(19) United States
(12) Patent Application Publication
(10) Pub. No.: US 2022/0153323 A1
(43) Pub. Date: May 19, 2022

(54) CONVEYANCE ARREST SYSTEM

(71) Applicant: Paul W. Budge, St. George, UT (US)

(72) Inventor: Paul W. Budge, St. George, UT (US)

(21) Appl. No.: 17/586,332

(22) Filed: Jan. 27, 2022

Related U.S. Application Data
(63) Continuation of application No. 16/396,942, filed on Apr. 29, 2019, now abandoned.

(51) Int. Cl. B61K 7/18; B61H 9/02; B61B 7/00

(52) U.S. Cl. CPC B61K 7/18; A63G 21/22; B61B 7/00; B61H 9/02

(57) ABSTRACT

A first conveyance arrest system includes a conveyance arrest cylinder comprising a piston rod mechanically coupled a trolley receiver. The trolley receiver engages a conveyance trolley, displaces the piston rod and pressurizes a working fluid within the conveyance arrest cylinder. The conveyance arrest cylinder comprises a port that vents pressurized fluid within the conveyance arrest cylinder and provides a vent resistance to fluid escaping the conveyance arrest cylinder. A second conveyance arrest system includes a conveyance trolley slideably coupled to a conveyance guide, and a conveyance arrest cylinder mechanically coupled to the conveyance trolley. The second conveyance arrest system also includes a conveyance stop configured to engage a stop engagement end of a piston rod and thereby pressurize fluid within the conveyance arrest cylinder in response to movement of the trolley toward the conveyance stop.

### REFERENCE TO RELATED APPLICATIONS

This application is a continuation-in-part of U.S. patent application Ser. No. 16/396,942 entitled “CONVEYANCE ARREST SYSTEM” and filed on 29 Apr. 2019 which is incorporated herein by reference.

### BACKGROUND

The present invention relates generally to transportation safety systems and more particularly to conveyance arrest systems.

Conveyance arrest systems are intended to protect users of conveyance systems such as ziplines from harm and accident.

### SUMMARY OF THE INVENTION

A first conveyance arrest system includes a conveyance arrest cylinder comprising a piston rod, a trolley receiver mechanically coupled to the piston rod, the trolley receiver configured to engage a conveyance trolley and displace the piston rod and pressurize a working fluid within the conveyance arrest cylinder in response to displacement of the trolley receiver by the conveyance trolley. The conveyance arrest cylinder comprises a port that vents pressurized fluid within the conveyance arrest cylinder and provides a vent resistance to fluid escaping the conveyance arrest cylinder.

A second conveyance arrest system includes a conveyance trolley slideably coupled to a conveyance guide, a conveyance arrest cylinder mechanically coupled to the conveyance trolley, the conveyance arrest cylinder comprising a piston rod having a stop engagement end and a port that vents pressurized fluid within the conveyance arrest cylinder and provides a vent resistance to fluid escaping the conveyance arrest cylinder. The second conveyance arrest system also includes a conveyance stop configured to engage the stop engagement end of the piston rod and thereby pressurize fluid within the conveyance arrest cylinder in response to movement of the trolley toward the conveyance stop.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1A is a perspective view illustration of a user using a zipline in accordance with the present disclosure;

FIG. 1B is a schematic diagram of one embodiment of a conveyance system in accordance with the present disclosure;

FIG. 2 is a schematic diagram of one embodiment of a conveyance arrest system in accordance with the present disclosure;

FIG. 3 is a schematic diagram of one embodiment of a conveyance arrest system with a remote pressure storage in accordance with the present disclosure;

FIG. 4 is a schematic diagram of one embodiment of a conveyance arrest system with an operation control in accordance with the present disclosure;

FIG. 5 is a schematic diagram of one embodiment of a conveyance arrest system with a spring in accordance with the present disclosure;

FIG. 6A is a schematic diagram of one embodiment of a piston assembly for a conveyance arrest system in accordance with the present disclosure;

FIG. 6B is a schematic block diagram of one embodiment of an arrest control system in accordance with the present disclosure;

FIG. 7A is a schematic diagram of one embodiment of a first carriage assembly and associated stop for a conveyance arrest system in accordance with the present disclosure;

FIG. 7B is a schematic diagram of one embodiment of a first carriage assembly and associated stop for a conveyance arrest system in accordance with the present disclosure;

FIG. 8 is an exploded view schematic diagram of one embodiment of a conveyance arrest device for a conveyance arrest system in accordance with the present disclosure;

FIG. 9A is a schematic diagram of a first embodiment of multiple conveyance arrest devices deployed in conveyance arrest system in accordance with the present disclosure;

FIG. 9B is a schematic diagram of a second embodiment of multiple conveyance arrest devices deployed in conveyance arrest system in accordance with the present disclosure; and

FIGS. 10A and 10B are respective top view and side view schematic diagrams of one embodiment of a conveyance arrest system in accordance with the present disclosure.

### DETAILED DESCRIPTION

Described herein are embodiments of a conveyance arrest system that vastly improves on previous conveyance arrest systems by providing a primary braking system that does not rely on operator actuation. As will be described in greater detail below, the conveyance arrest system includes a fluid pressure system coupled to a trolley receiver. The fluid pressure system, in some embodiments, compresses a fluid as a trolley applies force to the trolley receiver. In some embodiments, the fluid pressure system transfers a working fluid to a pressure storage in response to force applied by the trolley at the trolley receiver. In some embodiments, a flow controller controls the transfer of the working fluid to control a rate of movement of the trolley at the trolley receiver.

The description of elements in each figure may refer to elements of proceeding figures. Like numbers refer to like elements in all figures, including alternate embodiments of like elements.

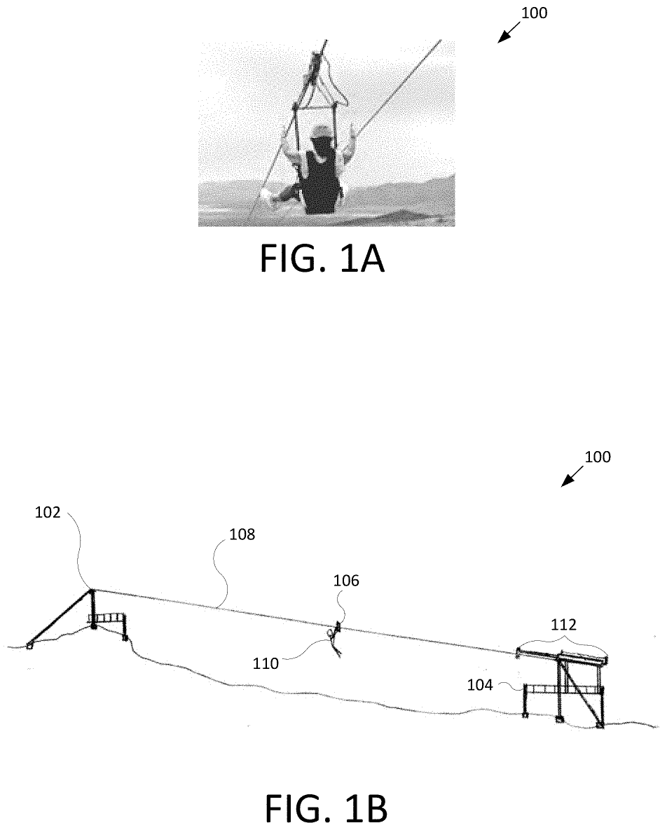

FIG. 1A is a perspective view illustration of a user using a zipline in accordance with the present disclosure. The depicted zipline is one example of a conveyance system 100 that can be equipped with conveyance arrest elements in accordance with the present disclosure.

FIG. 1B is a schematic diagram showing additional elements of one embodiment of a conveyance system 100 in accordance with the present disclosure. In the illustrated embodiment, the conveyance system 100 includes a launch point 102. In some embodiments, the launch point 102 includes a platform or other structure from which a rider may start a ride. In some embodiments, the launch point 102 is situated at a higher elevation relative to a landing point 104. In other embodiments, the launch point 102 is located level with or at a lower elevation relative to the landing point 104. In this arrangement, the conveyance system 100 may include a lift or other motivating system to take a trolley 106 to a higher elevation between the launch point 102 and the landing point 104.

In the illustrated embodiment, the launch point 102 and the landing point 104 are connected by a conveyance guide 108. In some embodiments, the conveyance guide 108 includes a cable, cord, or other line or rail with sufficient strength to support the trolley 106, a rider 110, and the weight of the conveyance guide 108 itself.

In the illustrated embodiment, the conveyance system 100 includes a single piece conveyance guide 108. In other embodiments, one or more sections of the conveyance guide 108 are positioned between the launch point 102 and the landing point 104. For example, the trolley 106 may transition from one conveyance portion to another conveyance portion. The conveyance system 100 may include additional landing points and other structures or features such as a towing portion to elevate the trolley 106 or a turning portion to redirect the trolley 106 around a turn.

In the illustrated embodiment, as the trolley 106 reaches the landing point 104, the trolley encounters the conveyance arrest system 112. In some embodiments, the conveyance arrest system 112 applies a force to the trolley 106 to slow and stop the trolley 106 at the landing point 104. In some embodiments, the conveyance arrest system 112 applies the force of the trolley 106 to a working fluid. The working fluid applies a reactive force to the conveyance arrest system 112 to slow and stop the trolley 106. In some embodiments, the working fluid includes at least one of a gas, or liquid. For example, the working fluid may be a pneumatic gas such as air, carbon dioxide, or the like. In another example, the working fluid may be a hydraulic fluid such as water, a hydraulic oil, or the like. Other working fluids may be used.

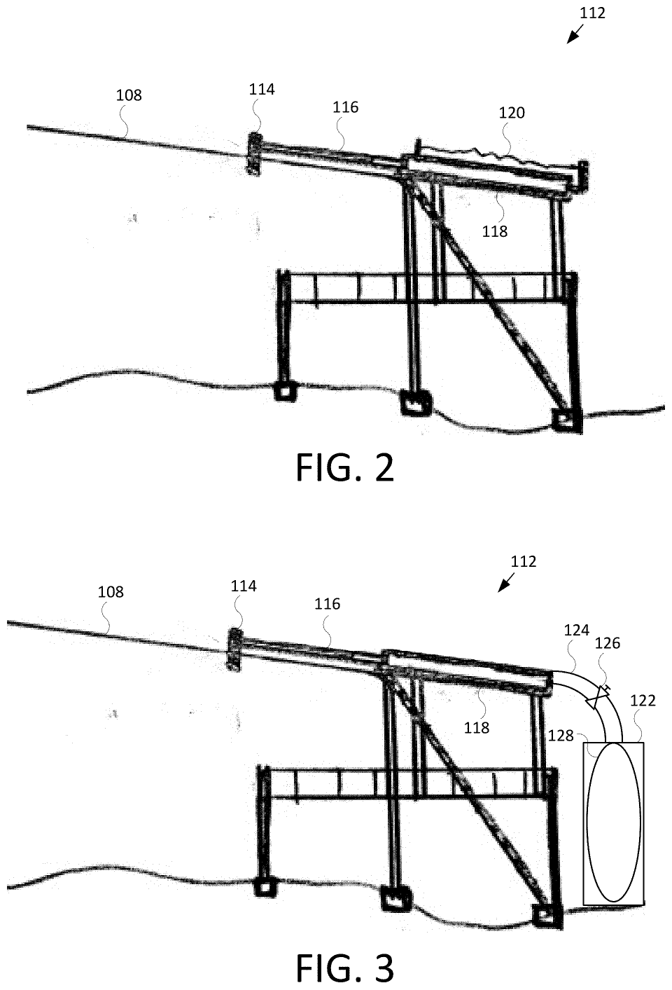

FIG. 2 is a schematic diagram of one embodiment of a conveyance arrest system 112 in accordance with the present disclosure. In the illustrated embodiment, the conveyance arrest system 112 includes a trolley receiver 114. In some embodiments, the trolley receiver 114 is oriented at, around, or near the conveyance guide 108 to receive a trolley traveling along the conveyance guide 108. In some embodiments, the trolley receiver 114 includes a catch to secure the trolley to the trolley receiver 114. The catch may be magnetic, mechanical, electrical, electromechanical, electromagnetic, or the like. In some embodiments, the catch couples to a corresponding structure on the trolley.

In some embodiments, the trolley receiver 114 includes a deformable surface such as a pad, spring, cushion, or the like to reduce the shock of an impact of the trolley arriving at the trolley receiver 114 or improve operation of the catch or reduce wear or damage to the conveyance arrest system 112, trolley, or other components. The deformable surface may be a mechanism or deformable material.

In some embodiments, the trolley receiver 114 is coupled to a fluid pressure system. In the illustrated embodiment, the fluid pressure system includes a conveyance arrest cylinder 115 comprising a piston rod 116 and housing or barrel 118. The piston rod 116 may be connected to a piston (not shown) that moves within the barrel 118. In some embodiments, the elements of the arrest cylinder 115 form a pneumatic system. In other embodiments, the elements of the arrest cylinder 115 form a hydraulic system. In some embodiments, the elements of the arrest cylinder 115 form a closed system. In other embodiments, the elements of the arrest cylinder 115 form an open system. In other embodiments, the pressure system includes a pump, dash pot, or other resistive element to apply a resistive force to the trolley receiver 114.

In the illustrated embodiment, the piston rod 116 is coupled to the trolley receiver 114 and moves with the trolley receiver 114 while the barrel 118 is fixed. In other embodiments, the barrel is coupled to the trolley receiver 114 and moves with the trolley receiver 114 while the piston rod 116 is actuated against a fixed object.

In the illustrated embodiment, the piston rod 116 and barrel 118 is aligned to have an axis and path of travel parallel with the conveyance guide 108. In other embodiments, the piston rod 116 and barrel 118 may be aligned to be non-parallel to the conveyance guide 108. For example, the piston rod 116 and barrel 118 may be positioned away from the conveyance guide 108 with a transmission system coupling the trolley receiver 114 to the piston rod 116 and the barrel 118. In some embodiments, the piston and the barrel 118 are sized in one or both of a diameter and a stroke length to provide sufficient travel to comfortably and safely stop a rider arriving at the end of the conveyance guide 108.

In the illustrated embodiment, a return system 120 is coupled to at least one of the piston rod 116 and barrel 118 to return the piston rod 116 and barrel 118 to a ready position. In some embodiments, the ready position is a relative orientation of the piston rod 116 is at least partially extended to receive a trolley at the trolley receiver 114.

In some embodiments, the return system 120 is at least one or a combination of a spring, a separate piston-cylinder, a pressure storage, a motor, a pump, a coil, a magnet, an elastic, and the like. In the illustrated embodiment, the return system 120 applies a return force to an end of the piston rod 116 distal to the trolley receiver 114 to extend the piston rod 116 to a ready position.

In some embodiments, the return system 120 is a passive system. The term “passive system” may refer to a system in which no energy is produced by the system. For example, a passive system may be a spring where no energy is produced but is only stored and released. In contrast, an example of an active system may include a motor with which mechanical energy is produced from electrical, mechanical or chemical sources.

In some embodiments, the return system 120 is aligned parallel with the barrel 118 and the piston rod 116. In other embodiments, the return system 120 is not parallel with the barrel 118 and the piston rod 116. Further embodiments of the return system 120 are described below.

FIG. 3 is a schematic diagram of one embodiment of a conveyance arrest system 112 with a pressure storage 122 in accordance with the present disclosure. In the illustrated embodiment, the pressure storage 122 is a pressure vessel that is coupled to the barrel 118 to receive and store a working fluid. In some embodiments, the pressure vessel is a tank, bag, hose, line, or other container or reservoir.

In the illustrated embodiment, the pressure storage 122 is coupled to the barrel 118 via a transmission line 124. In some embodiments, the transmission line 124 is a hydraulic or pneumatic line. In some embodiments, the transmission line 124 is flexible. In other embodiments, the transmission line 124 is rigid.

In some embodiments, the transmission line 124 couples the barrel 118 to the pressure storage 122 to transfer the working fluid from the barrel 118 as the piston rod 116 is moved into the barrel 118. In some embodiments, the pressure storage 122 applies a return force to act as a return system for returning the piston rod 116 and barrel 118 to a ready position similar to the return system 120 as described above with respect to FIG. 2.

In the illustrated embodiment, the transmission line 124 includes a flow controller 126. In some embodiments, the flow controller 126 is a valve or other permissive or restrictive system for controlling at least one of a volume, velocity, and direction of a flow of a working fluid through the transmission line 124. In some embodiments, the flow controller 126 is a check valve. In other embodiments, the flow controller 126 is a control valve. In some embodiments, the flow controller 126 is a pump. Other flow control systems are also contemplated.

In some embodiments, the flow controller 126 is operated manually by a user or other operating mechanism. In other embodiments, the flow controller 126 is operated by an automated system. For example, an automated controller may be implemented to operate the flow controller 126 based on one or more parameters including cylinder parameters. In some examples, the one or more parameters may include a current piston location, a current piston velocity, an inlet fluid flow rate, an inlet fluid pressure, an outlet fluid flow rate, an outlet fluid pressure, speed of the trolley, the weight of the rider and trolley, environmental conditions such as temperature, humidity, pressure, etc., a user setting, an input from a sensor or the like.

In the illustrated embodiment, the pressure storage 122 includes a flexible element 128. In the illustrated embodiment, the flexible element 128 includes an expansion chamber. For example, the expansion chamber may be an elastic or other material forming a flexible container which may be wholly or partially flexible in response to an increase in pressure within the expansion chamber.

While the flexible element 128 is shown as enclosed within the pressure storage 122, in some embodiments, the flexible element 128 may be at least partially exposed to the environment. In some embodiments, the pressure storage 122 is omitted with the transmission line 124 coupled directly to the flexible element 128. In some embodiments, the flexible element 128 is an extension of the transmission line 124. In other embodiments, the transmission line 124 is omitted and the flexible element 128 is coupled to the barrel 118 with or without the flow controller 126 interposed.

In some embodiment, the flexible element 128 is a flexible line that is coupled to the barrel 118. The flexible element 128 may be as long and as flexible as needed to accommodate the stroke length of the piston rod 116. In some embodiments, the flexible element 128 is sized to accommodate a safe and comfortable stopping rate for the trolley and rider. The flexible element 128 may have other geometries or forms to achieve other functionality.

In some embodiments, the flexible element 128 has a specific expansion behavior. For example, the flexible element 128 may be made of a material with a certain expansion characteristic and/or may be constricted in its expansion by a structure or material.

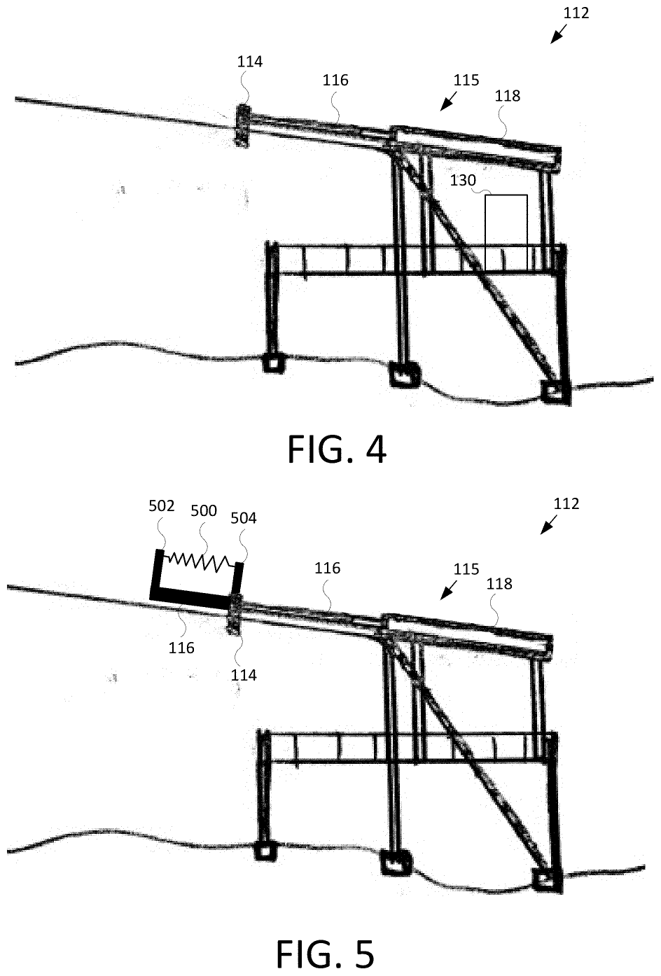

FIG. 4 is a schematic diagram of one embodiment of a conveyance arrest system 112 with an operation control 130 in accordance with the present disclosure. In the illustrated embodiment, the conveyance arrest system 112 incorporates the operation control 130 to manage control of the piston rod 116, the barrel 118, the trolley catch 114, and/or other components of the conveyance arrest system 112. While the illustrated embodiment shows the operation control 130 as a separate module, in other embodiments, the operation control 130 is integrated into the piston rod 116 and/or the barrel 118. The operation control 130 may also be incorporated with other elements of the conveyance arrest system 112 shown or described herein.

In some embodiments, the operation control 130 controls an operation of the conveyance arrest system 112. For example, the operation control 130 may control an aspect of the compression or extension of the piston rod 116, a capture of a trolley at the trolley receiver 114, a release of the trolley, a signaling of the launch point, an emergency operation, or the like. In some embodiments, the operation control 130 operates a catch on the trolley receiver 114 in response to impact of a trolley at the trolley receiver. In some embodiments, the operation control 130 operates the catch of the trolley receiver 114 to release the trolley.

In some embodiments, the operation control 130 operates a return system as described above to return the piston rod 116 to the ready position. In some embodiments, the operation control 130 controls a communicator (not shown) to indicate a state of the conveyance arrest system 112. For example, the operation control 130 may send a signal to a launch point 102 indicating that a rider may be sent to the landing point.

In some embodiments, the operation control 130 is operated by a user. For example, a user may interface with the operation control 130 to indicate that the conveyance arrest system 112 is ready to receive a rider or that an emergency situation is occurring. In other embodiments, the operation control 130 is at least partially automated. For example, the operation control 130 may include a processor, a field programmable gate array, a proportional-integral-derivative controller, a closed loop feedback controller, an open loop feedback controller, or the like.

In some embodiments, the operation control 130 includes or is in communication with one or more sensors (not shown). In some embodiments, the operation control 130 functions independent of user interaction based on sensor information. In other embodiments, the operation control 130 functions based on sensor information and user interaction. For example, the operation control 130 may receive a signal from a sensor, modify a display to indicate a state based on the signal from the sensor, and detect a user input to execute an operation.

In some embodiments, the user interaction supplements information determined from one or more sensor signals. For example, the operation control 130 may detect that the piston rod 116 is fully compressed within the barrel 118 and further detect a user input indicating that the rider has safely uncoupled from the zipline. In some embodiments, the operation control 130 also includes controls to operate the conveyance arrest system 112. For example, the operation control 130 may include an override to halt a current operation of the conveyance arrest system 112 or execute one or more operations of the conveyance arrest system 112.

In some embodiments, the conveyance arrest system 112 operates without a power requirement for any of the components of the conveyance arrest system 112. In other embodiments, one or more components of the conveyance arrest system 112 may operate on electrical or other power sources. In some embodiments, the conveyance arrest system 112 is coupled to a conventional power source such as a local power grid or generator. In other embodiments, the conveyance arrest system 112 includes a renewable energy source such as a solar panel, windmill, waterwheel, or the like which supplies power to the conveyance arrest system 112. Other embodiments include fewer or more components to facilitate fewer or more operations.

FIG. 5 is a schematic diagram of one embodiment of a conveyance arrest system 112 with a spring 500 in accordance with the present disclosure. In the illustrated embodiment, the piston rod 116 extends through the trolley receiver 114. In some embodiments, the trolley receiver 114 is translationally moves the piston rod 116. In some embodiments, the piston within the barrel 118 is hollow to reduce the weight and inertia of the piston. In the illustrated embodiment, the trolley receiver 114 is held in the illustrated ready position by the spring 500.

In some embodiments, the spring 500 is coupled to the piston rod 116 at a front-end connection point 502 of the piston rod 116. In some embodiments, the front-end connection point 502 of the piston rod 116 is a raised portion to maintain the spring 500 away from a trolley engaging the trolley receiver 114 and away from the piston rod 116. In some embodiments, the spring 500 may be open to the environment. In other embodiments, the spring 500 is at least partially positioned within an enclosure.

In some embodiments, the spring 500 couples to a receiver connection point 504 of the trolley receiver 114. In the illustrated embodiment, the receiver connection point 504 is a raised portion of the trolley receiver 114 to which the spring 500 is attached. In some embodiments, the height of the receiver connection point 504 and the front-end connection point 502 are equal to align an axis of the spring 500 with an axis of the piston rod 116. In other embodiments, the spring 500 and piston rod 116 may be offset or oriented at an angle relative to one another.

Upon receipt of a trolley at the trolley receiver 114, the trolley receiver 114 begins to slide along the piston rod 116. As the trolley receiver 114 slides along the piston rod 116, the relative displacement of the receiver connection point 504 on the trolley receiver 114 and the front-end connection point 502 on the piston rod 116 begins to extend the spring 500. The spring 500 acts a “soft start” or cushion for slowing the trolley to avoid an uncomfortable, jarring, or potentially unsafe engagement of the trolley with the conveyance arrest system 112.

In some embodiments, as the spring 500 begins to extend, it applies force to the piston rod 116 to compress the piston into the barrel 118. In other embodiments, the spring 500 begins to slow down the trolley receiver 114 relative to the piston rod 116 and, once the spring 500 is at or near full extension, the piston begins to compress into the barrel 118.

In some embodiments, the trolley receiver 114 may reach a physical stop (not shown) on the piston rod 116 prior to reaching full extension of the spring 500 to prevent damage or unnecessary wear to the spring 500. In some embodiments, the physical stop includes a catch to secure the trolley receiver 114 to prevent the spring 500 from rebounding or resetting the trolley receiver 114 before a rider is able to exit or disconnect from the trolley.

The spring 500 may also assist in returning the trolley receiver 114 to a ready position on the piston rod 116. In some embodiments, once the user has disembarked from the trolley, the trolley receiver 114 may be moved back into the ready position on the piston rod 116 by allowing the spring 500 to return to its non-extended or resting state.

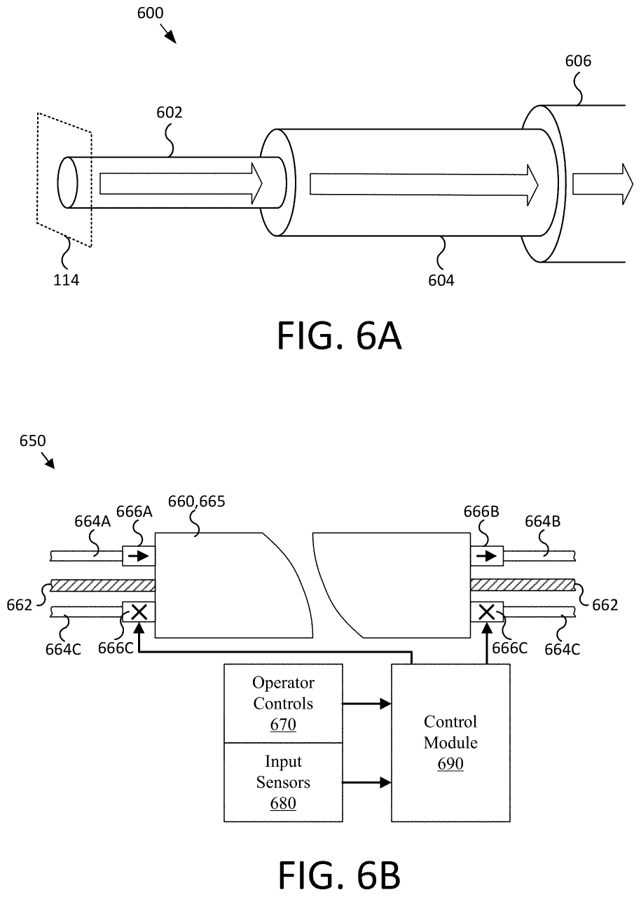

FIG. 6A is a schematic diagram of one embodiment of a piston assembly 600 for a conveyance arrest system 112 in accordance with the present disclosure. In the illustrated embodiment, the piston assembly 600 includes a first stage 602, a second stage 604 and a third stage 606.

In some embodiments, the first stage 602 is coupled to the trolley receiver 114. In other embodiments, some intermediate structure may couple the first stage 602 to the trolley receiver 114. In some embodiments, the first stage 602 has a smaller diameter than the second stage 604. In some embodiments, the first stage 602 is a piston sized to provide light slowing and impulse absorption in response to a trolley arriving at the conveyance arrest system 112.

In some embodiments, the first stage 602 compresses into the second stage 604 in response to force applied to the first stage 602. In some embodiments, the first stage 602 moves or compresses a working fluid within the second stage 604. In other embodiments, movement of the first stage 602 compresses or moves a working fluid located downstream or separate from the second stage 604. For example, compression of the first stage 602 may compress a reservoir such as the pressure storage 122 of FIG. 3.

In some embodiments, second stage 604 is similar to the first stage 602. In some embodiments, the second stage 604 has a larger diameter that the first stage 602 and compresses into the third stage 606. In some embodiments, the second stage 604 is contacted by the trolley receiver 114 once the first stage 602 is fully compressed. In other embodiments, the second stage 604 is compressed in response to compression of the first stage 602 reaching a compression limit of the first stage 602.

In some embodiments, the third stage 606 is similar to the first stage 602 and the second stage 604. In some embodiments, compression of the third stage 606 requires more force and therefore more rapidly reduces the speed of the trolley receiver 114.

In some embodiments, the operation of each of the first stage 602, the second stage 604, and the third stage 606 are similar. In other embodiments, the operation of one or more the first stage 602, the second stage 604, and the third stage 606 are different from another of the first stage 602, the second stage 604, and the third stage 606. In some embodiments, one or more of the first stage 602, the second stage 604, and the third stage 606 is configured to provide a non-linear resistance. For example, the force required to compress at least one of the first stage 602, the second stage 604, and the third stage 606 may increase or decrease relative to the position of the corresponding stage or stages.

While the illustrated embodiment includes the first stage 602, the second stage 604, and the third stage 606, other embodiments of the piston assembly 600 may include fewer or more stages. In some embodiments, movement of one of more of the first stage 602, the second stage 604, and the third stage 606 may be computer controlled. The first stage 602, the second stage 604, and the third stage 606 may use the same working fluid or may operate with different working fluids.

In some embodiments, one or more of the first stage 602, the second stage 604, and the third stage 606 may incorporate hollow rods or other lightening features. In some embodiments, the telescoping arrangement of the first stage 602, the second stage 604, and the third stage 606 provide a softer less abrupt arrest for the trolley and rider.

FIG. 6B is a schematic block diagram of one embodiment of an arrest control system 650 in accordance with the present disclosure. As depicted, the arrest control system 650 includes an arrest cylinder 660, operator controls 670, input sensors 680 and a control module 690. The arrest control system provides control over how a moving trolley or carriage is brought to rest.

The arrest cylinder 660 comprises a rod 662 connected to a piston (not shown) that moves within the housing or barrel 665 of the arrest cylinder 660 and acts upon a working fluid (not shown) such as air. The piston effectively partitions the barrel 665 into two variable-sized chambers. In the depicted arrangement, the left end of the piston rod 662 is assumed to be coupled to a trolley receiver (not shown) and trolley or carriage is assumed to move the trolley receiver, piston rod and piston from left to right as the trolley or carriage is brought to rest.

In the depicted embodiment, the cylinder 660 includes an inlet port 664A, an outlet port 664B, and one or more dynamic control ports 664C through which the working fluid can move. An inlet check valve 666A prevents the working fluid from exiting the cylinder 660 through the inlet port 664A. Similarly, an outlet check valve prevents the working fluid from entering the cylinder 660 from the outlet port 664B.

The dynamic control ports 664C enable working fluid to enter or exit the cylinder when a control valve 666C is open. Opening a control valve 666C effectively reduces the vent resistance to working fluid escaping the cylinder 660. In some embodiments, at least one of the control valve 666C is an ON/OFF valve that lowers the vent resistance a selected amount when open. The control valves 666C my also be variable valves that can be used to variably reduce the vent resistance provided by the outlet port 664B. In addition to changing the vent resistance, opening the control valve 666C on the left of the cylinder also enables the piston to be retracted to a starting position on the left side of the cylinder.

In some embodiments, the operator controls 670 enable an operator to control or influence the conveyance system 100. Examples of operator controls include a desired velocity, a maximum allowed velocity, a maximum expected load and a current passenger load.

In some embodiments, the input sensors 680 provide information that can be leveraged to provide a safe enjoyable experience for passengers of the conveyance system 100. Examples of input sensors include a current piston location, a current piston velocity, an inlet fluid flow rate, an inlet fluid pressure, an outlet fluid flow rate, an outlet fluid pressure, a current passenger load, and a current passenger velocity.

The control module 690 controls at least the dynamic control valve 666C. The control module 690 may also control aspects of the pressure storage 122 and/or transmission line 124. The control provided by the control module 690 may be mechanically, electrically, electromagnetically or photonically applied. In some embodiments, the control module 690 receives input from the operator controls 670 and/or the input sensors 690.

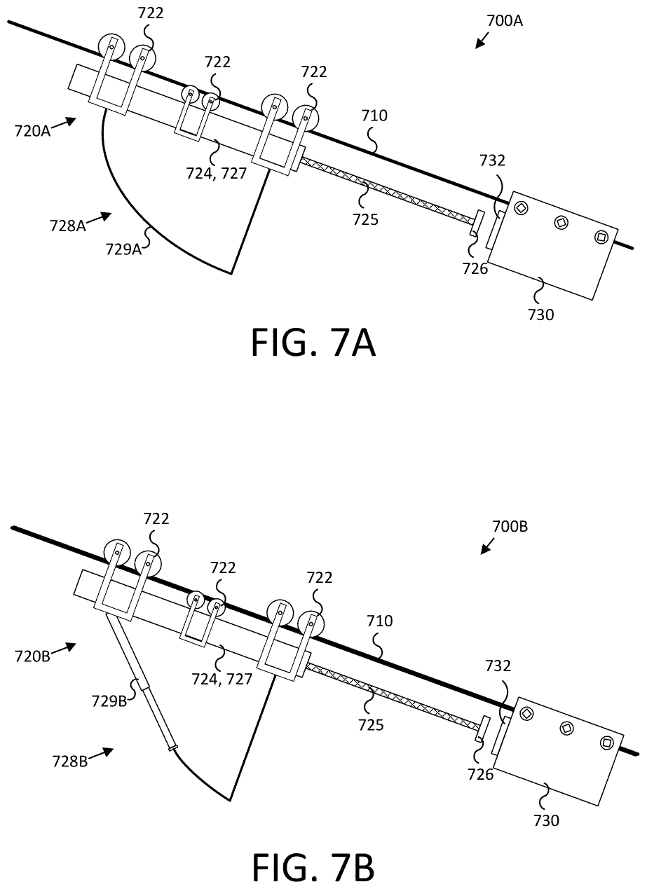

FIGS. 7A and 7B are respective schematic diagrams of one embodiment of a first trolley system 700A and a second trolley system 700B for a conveyance arrest system. As depicted, the trolley systems 700 include a conveyance guide 710, a trolley 720 and conveyance stop 730. The trolley systems 700 integrate a conveyance arrest system into a trolley 720A and a trolley 720B respectively.

The depicted conveyance guides 710 are cables such as those used in ziplines. The depicted trolleys 720 include guide rollers 722 which engage the guides 710 and rollably or slideably attach the trolleys 720 to the guides 710. The guide rollers 722 enable movement of the trolleys 720 along the guides 710 while also preventing separation of the trolleys 720 from the guides 710.

The depicted trolley systems 700 also include conveyance arrest cylinders 724. The conveyance arrest cylinders 724 enable arresting the movement of the trolleys 720 in response to engagement of a stop engagement end 726 of the piston rod 725 by a receiving member 732 on the conveyance stop 730. In the depicted arrangements, the piston rod 725 is connected to a piston (not shown) which moves within a barrel 727 of the conveyance arrest cylinders 724.

Engagement of the stop engagement end 726 of the piston rod pressurizes fluid within the conveyance arrest cylinder 724 in response to movement of the trolley 720 toward the conveyance stop 730. In some embodiments, a port (not shown in FIGS. 7A and 7B, see FIG. 6B and the associated description) within the conveyance arrest cylinder vents pressurized fluid within the conveyance arrest cylinder and provides a vent resistance to (working) fluid escaping the conveyance arrest cylinder. In the depicted embodiments, the conveyance stop 730 is affixed to the conveyance guide 710.

The depicted trolleys 720 (i.e., 720A and 720B) also include a passenger support structure 728 (i.e., 728A or 728B) that includes one more ride smoothing elements 729 (e.g., 729A or 729B) that dampen movement of the passenger (not shown) relative to the trolley 720. In FIG. 7A the ride smoothing element 729 is a strut 729A and in FIG. 7B the ride smoothing element 729 is a shock absorber or cylinder 729B.

The depicted trolley systems 700 may include additional elements that are omitted for the sake of clarity and simplicity. For example, the conveyance arrest cylinders may include additional elements depicted in conjunction with the piston assembly 600 and the arrest control system 650 depicted in FIGS. 6A and 6B.

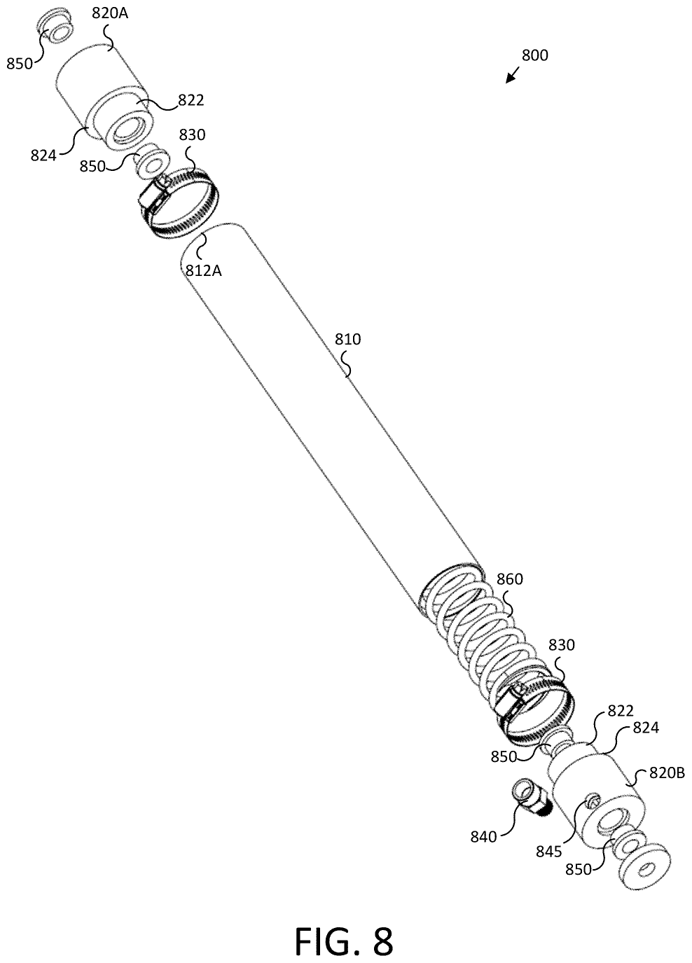

FIG. 8 is an exploded view schematic diagram of one embodiment of a conveyance arrest device 800 for a conveyance arrest system in accordance with the present disclosure. As depicted, the conveyance arrest device 800 includes a flexible tube 810, a first annular cylinder 820A disposed at a first end 812A of the flexible tube 810 and a second annular cylinder disposed at a second end 812A of the flexible tube 810. When assembled, the flexible tube 810 encompasses at least a portion of an outer surface of the first annular cylinder 820A and an outer surface of the second annular cylinder 820B.

The first end 812A of the flexible tube 810 may (or may not) be sealed against the outer surface of the first annular cylinder 820A and the second end 812B of flexible tube 810 may (or may not) be sealed against the outer surface of the second annular cylinder 820B. Sealing of the ends of the flexible tube 810 to the annular cylinders 820A and 820B may be accomplished via a sealant or one or more tube clamps 830. The conveyance arrest device 800 may be disposed around a cable or rod of a conveyance system (not shown in FIG. 8). In some embodiments, the flexible tube 810 is ribbed to improve longitudinal compressibility or tensile strength.

The depicted embodiment includes a check valve 840 mounted on a port 845 disposed on the second annular cylinder 820B. Alternately, the check valve 840 may be mounted on a port 845 disposed on the first annular cylinder 820A. The port 845 enables pneumatic communication with the interior of the flexible tube 810. The check valve 840 may vent the interior of the flexible tube 810 via the port 845 when a selected pressure is exceeded. A bushing 850 may be disposed within each end of the first and second annular cylinders. The bushings 850 may reduce friction as well as leakage of pressurized air within the flexible tube 810.

In some embodiments, a compression spring 860 is disposed within the flexible tube 810 and between the first and second annular cylinders 820A and 820B. The first annular cylinder and the second annular cylinder may comprise a neck portion 822 that fits within an interior of the compression spring 860 and a shoulder portion 824 that engages an end of the compression spring 860. In certain embodiments, the compression spring 860 is integral to the flexible tube.

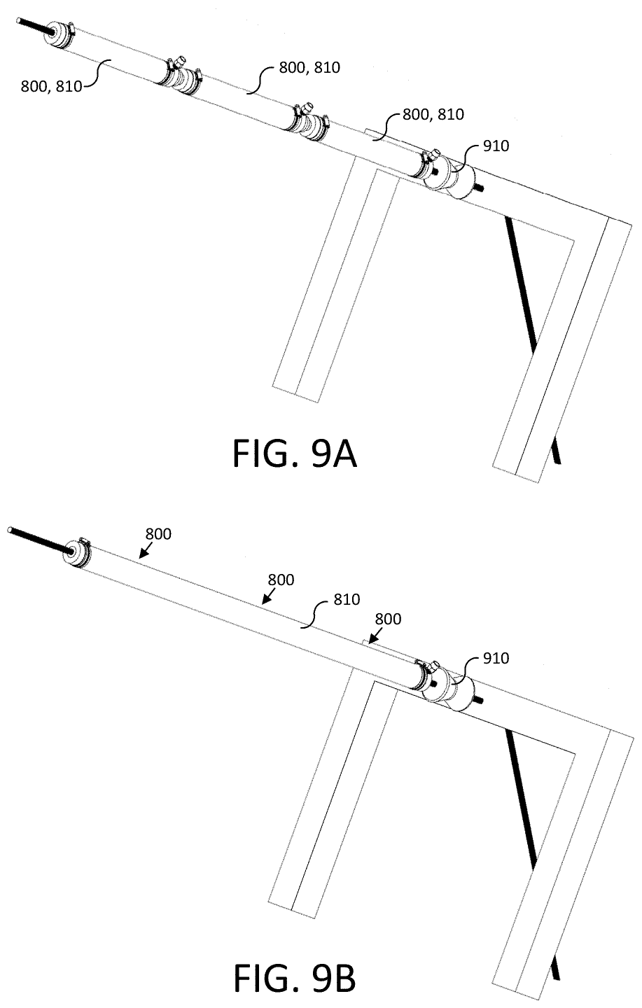

FIG. 9A is a schematic diagram of a first embodiment and FIG. 9B is a schematic diagram of a second embodiment of multiple conveyance arrest devices 800 deployed in conveyance arrest system in accordance with the present disclosure. Each embodiment depicts three conveyance arrest devices 800 disposed in series around a cable or rod of a conveyance arrest system. The first embodiment of FIG. 9A shows a separate flexible tube 810 for each conveyance arrest device 800. The second embodiment of FIG. 9B shows a single flexible tube 810 that encompasses three conveyance arrest devices 800 (which are not separately visible). FIG. 9A and FIG. 9B also include a crushing collar 910 that collapses when a maximum recommended load has been exceeded. In response thereto, operators may check the integrity of the conveyance system and replace the crushing collar 910.

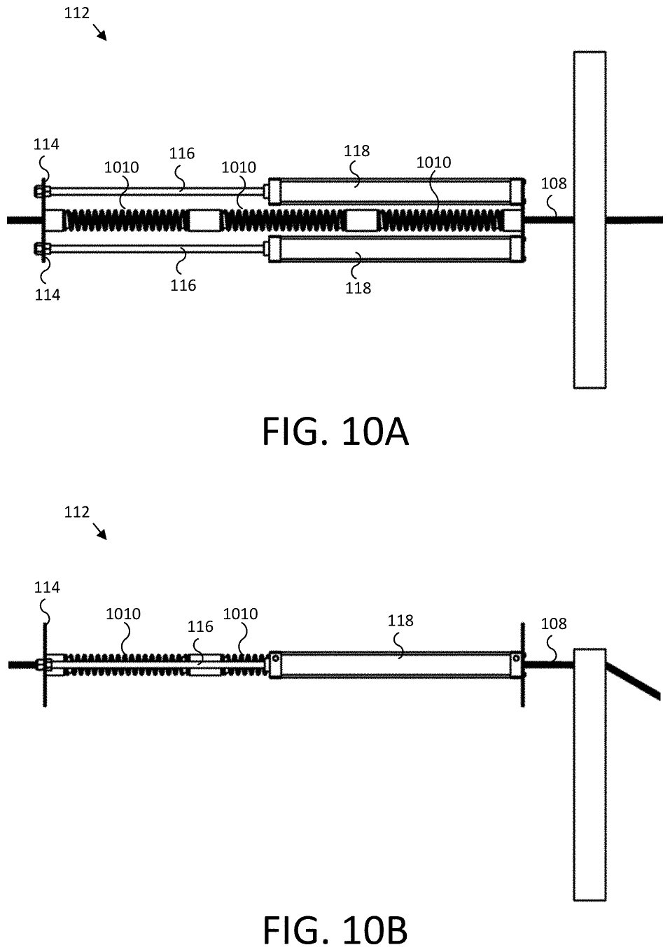

FIGS. 10A and 10B are respective top view and side view schematic diagrams of portions of one embodiment of a conveyance arrest system 112 in accordance with the present disclosure. The conveyance arrest system 112 integrates with a conveyance guide 108 and includes one or more compression springs 1010 and at least one conveyance arrest cylinder 115. As previously described the conveyance arrest cylinders 115 may comprise a piston (not shown), a piston rod 116 and a barrel or housing 118. The conveyance arrest cylinders 115 may be disposed parallel to the compression springs 1010.

A trolley receiver 114 may be mechanically coupled to one end of the compression spring(s) 1010 and the piston rod 116 of each conveyance arrest cylinder 115. The trolley receiver 114 may be configured to engage a conveyance trolley (not shown in FIGS. 10A and 10B) and displace the piston rod 116 and pressurize a working fluid within the conveyance arrest cylinder 115 in response to displacement of the trolley receiver by the conveyance trolley.

Each conveyance arrest cylinders 115 may comprise a port that vents pressurized fluid within the conveyance arrest cylinder and provides a vent resistance to fluid escaping the conveyance arrest cylinder. The compression spring(s) 1010 may return each conveyance arrest cylinder 115 to an unpressurized state in response to disengagement of the conveyance trolley.

One of skill in the art will appreciate that the conveyance arrest systems and devices presented herein enable arresting of a passengers momentum in a safe, effective and convenient manner.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A conveyance arrest system comprising:
a conveyance arrest cylinder comprising a barrel, a piston and a piston rod coupled to the piston;
a trolley receiver mechanically coupled to the piston rod, the trolley receiver configured to engage a conveyance trolley and displace the piston rod and pressurize a working fluid within the conveyance arrest cylinder in response to displacement of the trolley receiver by the conveyance trolley; and
wherein the conveyance arrest cylinder comprises at least one port that vents pressurized fluid within the conveyance arrest cylinder and provides a vent resistance to fluid escaping the conveyance arrest cylinder.

2. The conveyance arrest system of claim 1, wherein the vent resistance is selected to arrest a maximum expected load on the conveyance trolley over an operational displacement distance of the trolley receiver.

3. The conveyance arrest system of claim 1, wherein the vent resistance is adjustable.

4. The conveyance arrest system of claim 1, wherein the conveyance arrest system comprises one or more operator controls that effect a change in the vent resistance.

5. The conveyance arrest system of claim 1, wherein the one or more operator controls comprise one or more of a control for selecting a maximum desired velocity for the trolley and a control for selecting a maximum expected load for the trolley.

6. The conveyance arrest system of claim 1, wherein the conveyance arrest system further comprises a control system that measures at least one cylinder parameter and adjusts the vent resistance according to the at least one cylinder parameter.

7. The conveyance arrest system of claim 1, wherein the at least one cylinder parameter comprises one or more of a displacement distance, a displacement velocity and a cylinder pressure.

8. The conveyance arrest system of claim 1, wherein the port is pneumatically or hydraulically coupled to a fluid pressure system.

9. The conveyance arrest system of claim 1, wherein the fluid pressure system comprises a fluid storage vessel.

10. The conveyance arrest system of claim 1, wherein the fluid pressure system effects a change in the vent resistance as fluid is provided by the port.

11. The conveyance arrest system of claim 1, wherein the fluid pressure system comprises a flow controller.

12. The conveyance arrest system of claim 1, wherein the flow controller at least partially effects a change in the vent resistance according to a displacement rate of the trolley receiver.

13. The conveyance arrest system of claim 1, wherein the conveyance arrest cylinder comprises two or more telescoping stages.

14. The conveyance arrest system of claim 1, wherein the working fluid within the conveyance arrest cylinder comprises at least one of oil, air and water.

15. A conveyance arrest system comprising:
a conveyance trolley slideably coupled to a conveyance guide;
a conveyance arrest cylinder mechanically coupled to the conveyance trolley, the conveyance arrest cylinder comprising a barrel, a piston and a piston rod coupled to the piston, the piston rod having a stop engagement end;
a conveyance stop, the conveyance stop configured to engage the stop engagement end of the piston rod and thereby pressurize fluid within the conveyance arrest cylinder in response to movement of the trolley toward the conveyance stop; and
wherein the conveyance arrest cylinder comprises a port that vents pressurized fluid within the conveyance arrest cylinder and provides a vent resistance to fluid escaping the conveyance arrest cylinder.

16. The conveyance arrest system of claim 15, wherein the working fluid within the conveyance arrest cylinder comprises at least one of oil, air and water.

17. The conveyance arrest system of claim 15, wherein the conveyance stop is affixed to the conveyance guide.

18. The conveyance arrest system of claim 15, wherein the vent resistance is adjustable.

19. The conveyance arrest system of claim 15, further comprising a control system that measures at least one conveyance arrest cylinder parameter and adjusts the vent resistance according to the conveyance arrest cylinder parameter.

20. The conveyance arrest system of claim 15, further comprising an operator control that effects a change in the vent resistance wherein the operator controls is selected from the group consisting of a control for selecting a maximum expected velocity for the trolley and a control for selecting a maximum expected load for the trolley.
